(19) United States
(12) Patent Application Publication
(10) Pub. No.: US 2006/0256824 A1
(43) Pub. Date: Nov. 16, 2006

(54) Semiconductor laser pumped solid device

(76) Inventor: Tsuyoshi Suzudo, Miyagi (JP)

Correspondence Address: DICKSTEIN SHAPIRO LLP, 1825 EYE STREET NW, Washington, DC, 20006-5403, US

(21) Appl. No.: 11/375,137

(22) Filed: Mar. 15, 2006

(30) Foreign Application Priority Data
Mar. 17, 2005 (JP) 2005-077564

(51) Int. Cl. H01S 3/16; H01S 3/14; H01S 3/094

(52) U.S. Cl. 372/41; 372/75; 372/68

(57) ABSTRACT

A semiconductor laser pumped solid laser device is disclosed which enables a reduced size and high light output easily. The semiconductor laser pumped solid laser device has a plate-like laser material, and a semiconductor laser that emits a laser beam to pump the plate-like laser material to induce laser oscillation. Two end surfaces of the plate-like laser material act as two resonance surfaces of a resonator, and pumping light is introduced into the resonator through other side surface of the resonator than the resonance surfaces; the plate-like laser material includes plural regions each having different absorption coefficients and possesses finite absorption coefficients for the pumping light of different wavelengths, and absorption of the pumping light by the plate-like laser material is a maximum near a center of the plate-like laser material along an incident direction of the pumping light.

### BACKGROUND OF THE INVENTION

1. Field of the Invention

The present invention relates to a semiconductor laser pumped solid laser device, which can be used as a light source in an optical pickup device, a laser printer, a laser scan display.

2. Description of the Related Art

In recent years, devices using laser beams are used put into practical use, such as an optical disk device, a laser printer, a laser measurement device. In addition, in order for practical use in the future, study and development have been made of a laser display. In the laser display, it is required that the wavelength of the laser beam be short, and light sources having the three primary colors (Red, Blue, Green) be used. For this purpose, the semiconductor laser devices and wavelength-convertible laser devices have been extensively studied. Especially, study is being extensively made to apply a wavelength-convertible light source having a solid laser to a laser device of a high output (about 10 W).

When application to the laser display is intended, it is indispensable to make the laser device compact, and at the same time it is preferable that the output of the laser device be high. To obtain such a compact and high output laser device, it is effective to use a micro-chip laser structure, in which a thin plate-like is used as the laser material.

For example, semiconductor laser pumped solid laser devices, in which a laser beam from a semiconductor laser is used to pump a laser material, are disclosed in Japanese Laid-Open Patent Application No. 5-183220 (hereinafter referred to as “reference 1”), Japanese Laid-Open Patent Application No. 11-177167 (hereinafter referred to as “reference 2”), U.S. Pat. No. 5,553,088 (hereinafter referred to as “reference 3”), and JJAP Vol. 41 (2002), pp. L606-L608 (hereinafter referred to as “reference 4”).

In the semiconductor lasers disclosed in reference 1 and reference 2, the laser beam from a semiconductor laser is incident in the same direction as the exit direction of the laser beam to pump the laser material, namely, the semiconductor lasers have an end-pumped structure. However, because power of the laser beam from the semiconductor laser is limited, and because of heat release problem, it is difficult for the semiconductor laser to have a high output.

In the semiconductor lasers disclosed in reference 3 and reference 4, the laser beam from a semiconductor laser is incident in a laser crystal from a lateral side for laser pumping. However, these devices have quite complicated structures, and cannot be made compact easily.

### SUMMARY OF THE INVENTION

A general object of the present invention is to solve one or more problems of the related art.

A specific object of the present invention is to provide a semiconductor laser pumped solid laser device which enables a reduced size and high light output easily.

According to an aspect of the present invention, there is provided a semiconductor laser pumped solid laser device, comprising: a plate-like laser material; and a semiconductor laser that emits a laser beam to pump the plate-like laser material to induce laser oscillation, wherein two end surfaces of the plate-like laser material act as two resonance surfaces of a resonator with pumping light being introduced into the resonator through other side surface of the resonator than the resonance surfaces, the plate-like laser material includes a plurality of regions each having different absorption coefficients and possesses finite absorption coefficients for the pumping light of different wavelengths, and absorption of the pumping light by the plate-like laser material is a maximum near a center of the plate-like laser material along an incident direction of the pumping light.

As an embodiment, the laser beam from the semiconductor laser capable of side-surface pumping is incident in only one direction. Alternatively, the laser beam from the semiconductor laser capable of side-surface pumping is incident in a plurality of directions.

As an embodiment, the laser material is a single and uniaxial crystal, and absorption of the pumping light by the laser material is adjusted by a dose of a dopant in the laser material.

As an embodiment, the laser material is obtained by doping a dopant into GdVO₄.

As an embodiment, the laser material is a ceramic material, and absorption of the pumping light by the laser material is adjusted by a dose of a dopant in the laser material. As an embodiment, the laser material is obtained by doping a dopant into YAG ceramics.

As an embodiment, the dopant in the laser material is Nd.

According to the present invention, in the semiconductor laser pumped solid laser device of the present invention, a laser beam from a semiconductor laser for pumping is incident into the plate-like laser material, whose two end surfaces are resonance surfaces, from a side surface other than the resonance surfaces of the laser material. The plate-like laser material is able to absorb all the pumping light of different wavelengths, and includes a plurality of regions having different absorption coefficients. In addition, absorption of the pumping light by the plate-like laser material is a maximum near a center portion of the plate-like laser material where the pumping light is incident.

Since the pumping light, which is a laser beam from a semiconductor laser, is incident into the resonator through one side surface of the resonator other than the resonance surfaces, because of the pumping light, dopant in the laser material is excited, and induced emission due to resonance of the surfaces of the resonator. Because the two end surfaces of the plate-like laser material serve as the two resonance surfaces, the laser beam is irradiated directly from the laser material.

The semiconductor laser pumped solid laser device of the present invention has a microchip structure, that is, the semiconductor laser pumped solid laser device has a resonator with two end surfaces of the laser material being two resonance surfaces. In a usual microchip structure, the absorption profile of the pumping light in the laser material greatly influences the transverse mode of the laser. In the present invention, because the absorbed portion of the pumping light is a maximum near the center portion of the laser material along an incident direction of the pumping light, it is possible to obtain good laser oscillation of the laser transverse mode with both a compact microchip laser structure and a side-surface pumping structure of high output.

These and other objects, features, and advantages of the present invention will become more apparent from the following detailed description of preferred embodiments given with reference to the accompanying drawings.

### BRIEF DESCRIPTION OF THE DRAWINGS

FIG. 1 is a schematic view illustrating a configuration of a semiconductor laser pumped solid laser device according to an embodiment of the present invention;

FIG. 2 is a schematic perspective view of the laser material 13;

FIG. 3A and FIG. 3B exemplify absorption profiles of the pumping light in the laser material 13;

FIG. 4 is a schematic view illustrating a configuration of a semiconductor laser pumped solid laser device according to a second embodiment of the present invention; and

FIG. 5A and FIG. 5B exemplify absorption profiles of the pumping light in the laser material 43.

### DESCRIPTION OF THE PREFERRED EMBODIMENTS

Below, preferred embodiments of the present invention are explained with reference to the accompanying drawings.

### First Embodiment

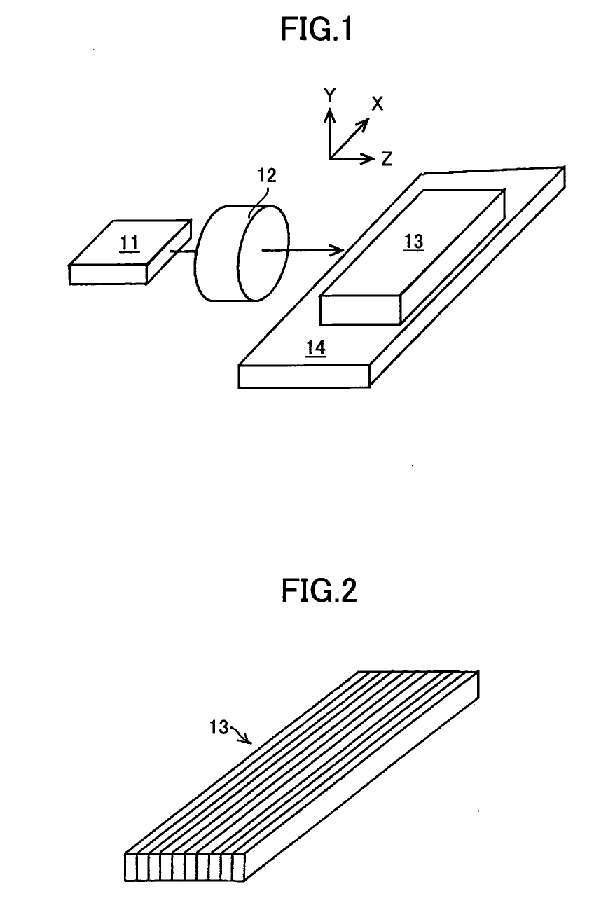

FIG. 1 is a schematic view illustrating a configuration of a semiconductor laser pumped solid laser device according to a first embodiment of the present invention.

As shown in FIG. 1, the semiconductor laser pumped solid laser device includes a semiconductor laser 11, a semiconductor laser optical system 12, a laser material 13, and a radiator plate 14. The semiconductor laser 11 has a wavelength of 808 nm, and the output is 2 W. X, Y, Z directions are defined in a coordinate as shown in FIG. 1.

The semiconductor laser optical system 12 includes a combination of one or more lens units. When the laser beam from the semiconductor laser 11 is incident to the laser material 13, the semiconductor laser optical system 12 adjusts the laser beam to be a parallel beam of a beam diameter of 0.5 mm.

The laser material 13 is obtained by doping Nd into single crystal GdVO₄.

FIG. 2 is a schematic perspective view of the laser material 13.

In FIG. 2, along the light incidence direction (Z direction), the laser material 13 has plural regions each having different absorption coefficients.

As shown in FIG. 2, for example, the laser material 13 constitutes 10 strip-like thin plates of Nd-doped GdVO₄ single crystal are optically bonded in the thickness direction to be one piece,

As for the corresponding relation with the coordinate system in FIG. 1, the incidence direction of the pumping light is in the Z direction, and the bonding direction of the strip-like GdVO₄ single crystals is in the Z direction, and the longitudinal direction is in the X direction.

The 10 strip-like GdVO₄ single crystals have different doses of Nd according to the positions of the GdVO₄ single crystal strips in the laser material 13. For example, the dose of Nd in one GdVO₄ single crystal strips is uniform.

With doses of Nd in each of the 10 strip-like GdVO₄ single crystals, which are optically bonded into one piece, being adjusted appropriately, the laser material 13 is able to absorb pumping light in the whole wavelength region (namely, the laser material 13 has finite absorption coefficients for the pumping light in the whole wavelength region), and these plural strip-like regions have different absorption coefficients, and absorption of the pumping light in the laser material is a maximum near a center of the laser material along the incident direction of the pumping light (the Z direction).

For example, the dimensions of the laser material 13 may be 0.5 mm in the incident direction of the pumping light, that is, the Z direction (short side direction), 2 mm in the X direction (long side direction), and 0.5 mm in the Y direction (thickness side direction). The absorption coefficients of different GdVO₄ single crystal strips in the Z direction are summarized below.

TABLE 1
Absorption coefficients in Z direction

| Regions in Z direction | Absorption coefficient (cm⁻¹) |
|---|---|
| 0 mm - 0.05 mm | 5 |
| 0.05 mm - 0.10 mm | 10 |
| 0.10 mm - 0.15 mm | 20 |
| 0.15 mm - 0.20 mm | 20 |
| 0.20 mm - 0.25 mm | 80 |
| 0.25 mm - 0.30 mm | 80 |
| 0.35 mm - 0.35 mm | 80 |
| 0.35 mm - 0.40 mm | 80 |
| 0.40 mm - 0.45 mm | 80 |
| 0.45 mm - 0.50 mm | 80 |

The laser material 13 is mounted by soldering on the radiator plate 14 formed from a copper plate (for example, the dimension of the laser material 13 is 1.0 mm in the Z direction, 5 mm in the X direction, and 2 mm in the Y direction). The two end surfaces of the laser material 13 act as two resonance surfaces of a parallel plate optical resonator, for this purpose, coating is applied on the two end surfaces of the laser material 13 (the two end surfaces in the Y direction), and the end surface of the laser material 13 in contact with the radiator plate 14 totally reflects light having a wavelength of 1063 nm, and the opposite end surface of the laser material 13 allows the light having a wavelength of 1063 nm to transmit at a light transmittance of 3%.

The pumping light (laser beam) from the semiconductor laser 11 is collimated by the semiconductor laser optical system 12, for example, the pumping laser is converted into a parallel beam having a beam diameter of about 0.5 mm, and is incident into the laser material 13 through a side surface (the side surface perpendicular to the Z direction in FIG. 1) other than the resonance surfaces of the laser material 13.

The pumping light incident into the laser material 13 excites the Nd dopant in the laser material, and generates induced emission due to resonance of the resonance surfaces (surfaces in the Y direction) to introduce laser oscillation and to emit laser beams in the Y direction from the end surface of the laser material 13 not in contact with the radiator plate 14.

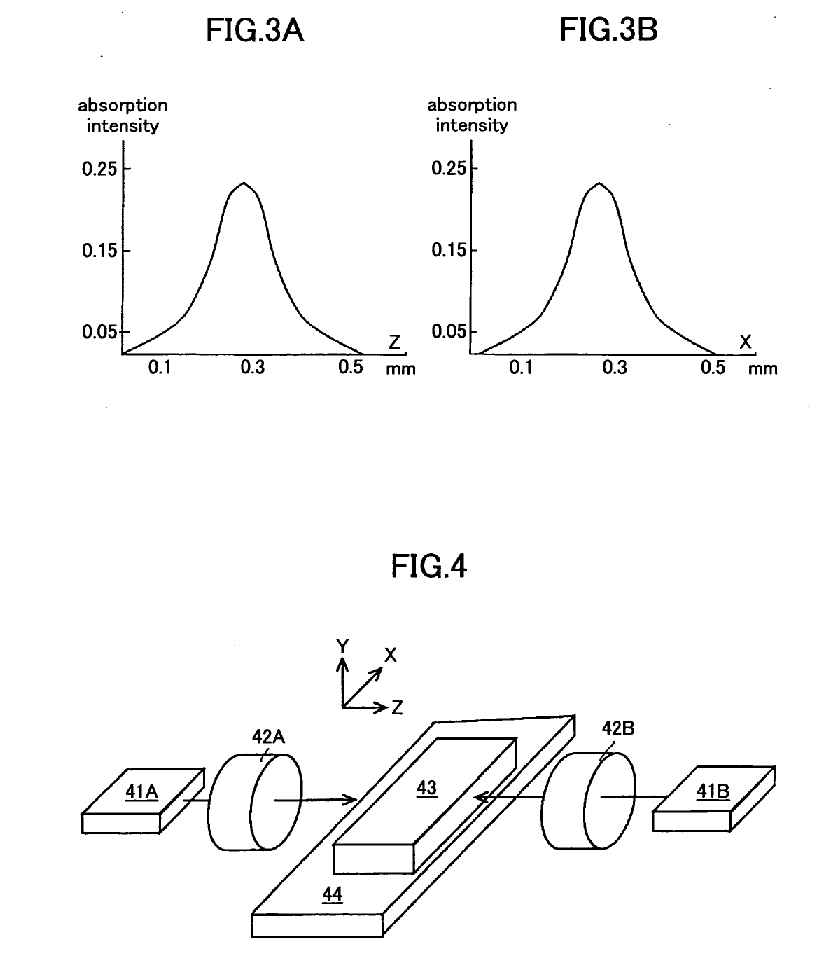

By arranging the absorption coefficients of different regions of the laser material 13 in the Z direction as summarized in Table 1, the absorption profiles of the pumping light as shown in FIG. 3A and FIG. 3B are obtained.

FIG. 3A and FIG. 3B exemplify absorption profiles of the pumping light in the laser material 13.

As shown in FIG. 3A and FIG. 3B, the light absorption reaches a maximum near the center of the laser material 13 in the X and Z direction, and decreases gradually toward two sides.

FIG. 3A exemplifies the absorption profile of the pumping light in the laser material 13 in the Z direction.

The absorption profile in the Z direction is ascribed to the distribution of the absorption coefficients of the pumping light in the laser material 13 in the Z direction as summarized in Table 1.

FIG. 3B exemplifies the absorption profile of the pumping light in the laser material 13 in the X direction.

The absorption profile in the X direction is ascribed to the fact that the incident pumping light, which has a beam diameter of 0.5 mm equaling to the width of the laser material 13 in the Z direction, has a Gaussian intensity distribution relative to the optical axis.

In a microchip laser structure, which uses the two end surfaces of the laser material as resonance surfaces, the transverse mode of the outgoing laser is greatly influenced by the absorption profile of the pumping light in the laser material. In the present embodiment, the absorption profiles of the pumping light as shown in FIG. 3A and FIG. 3B are similar to the absorption profiles obtained with a side-surface pumping structure, in which laser pumping occurs on a side opposite to the laser emission side. Namely, it is possible to obtain the laser transverse mode similar to that in an end surface pumping structure while using the side-surface pumping structure.

In the above, as an example, it is described that the pumping light from a single semiconductor laser 11. Certainly, laser beams from a semiconductor laser array or other methods of increasing the light intensity can also be used. In this case, since the laser material 13 can be arranged to be in contact with the radiator plate 14, it is possible to obtain stable light output at a transverse mode. Even when comparing to a composite laser material, because the distribution of the absorption coefficients of the pumping light in the laser material 13 can be adjusted according to the dose of the Nd dopant, the transverse mode is in good condition.

In addition, it is possible to obtain a compact device enabling the transverse mode is in good condition with the pumping light being incident from only one direction. In addition, using the Nd:GdVO₄ as the laser material 13, it is possible to improve the transparency, and it is possible to reduce the size of the laser material and improve the efficiency because the absorption can be increased by aligning the polarization direction of the pumping light in the C axis direction. Thus, the cost of the laser material can be reduced, in addition, because the laser material also has a high thermal conductivity, it is possible to prevent declination of light output caused by heat.

The distribution of the absorption coefficients of the pumping light in the laser material 13 is not limited to that in Table 1, but can be optimized depending on the profile of the pumping light beam or the required transverse mode. In addition, the laser material 13 is not limited to the Nd:GdVO₄ single crystal, for example, it can also be YVO₄.

### Second Embodiment

FIG. 4 is a schematic view illustrating a configuration of a semiconductor laser pumped solid laser device according to a second embodiment of the present invention.

As shown in FIG. 4, the semiconductor laser pumped solid laser device includes semiconductor lasers 41A, 41B, semiconductor laser optical systems 42A, 42B, a laser material 43, and a radiator plate 44.

Both the semiconductor lasers 41A and 41B have a wavelength of 808 nm, and the output of 2 W, and are arranged on sides of the laser material 43.

The semiconductor laser optical systems 42A and 42B have the same structure, that is, each of which includes a combination of one or more lens units. The semiconductor laser optical systems 42A and 42B convert the laser beam from the semiconductor lasers 41A and 41B to be a parallel beam of a beam diameter of 0.5 mm and direct the laser beam to the laser material 43.

The laser material 43 is obtained by doping Nd into a YAG ceramics.

The laser material 43 has the same structure as that illustrated in FIG. 2. Specifically, strip-like thin plates of Nd-doped YAG ceramics are bonded in the thickness direction under the semi-annealing condition and become one piece be sintering.

With doses of Nd in each of the 10 strip-like YAG ceramics being adjusted appropriately, the laser material 43 is able to absorb the pumping light in the whole wavelength region (namely, the laser material 43 has finite absorption coefficients for the pumping light in the whole wavelength region), and these plural strip-like regions have different absorption coefficients, and absorption of the pumping light in the laser material is a maximum near a center of the laser material along the incident direction of the pumping light (the Z direction).

For example, the dimensions of the laser material 43 may be 0.5 mm in the incident direction of the pumping light, that is, the Z direction (short side direction), 2 mm in the X direction (long side direction), and 0.5 mm in the Y direction (thickness side direction). The absorption coefficients of different No-doped YAG ceramics strips in the Z direction are summarized below.

TABLE 2
Absorption coefficients in Z direction

| Regions in Z direction | Absorption coefficient (cm⁻¹) |
|---|---|
| 0 mm - 0.05 mm | 5 |
| 0.05 mm - 0.10 mm | 10 |
| 0.10 mm - 0.15 mm | 20 |
| 0.15 mm - 0.20 mm | 20 |
| 0.20 mm - 0.25 mm | 40 |
| 0.25 mm - 0.30 mm | 80 |
| 0.35 mm - 0.35 mm | 40 |
| 0.35 mm - 0.40 mm | 20 |
| 0.40 mm - 0.45 mm | 10 |
| 0.45 mm - 0.50 mm | 5 |

The laser material 43 is mounted by soldering on the radiator plate 44 formed from a copper plate (for example, the dimension of the laser material 43 is 1.0 mm in the Z direction, 5 mm in the X direction, and 2 mm in the Y direction). The two end surfaces of the laser material 43 act as two resonance surfaces of a parallel plate optical resonator, for this purpose, coating is applied on the two end surfaces of the laser material 43 (the two end surfaces in the Y direction), and the end surface of the laser material 43 in contact with the radiator plate 44 totally reflects light having a wavelength of 1064 nm, and the opposite end surface of the laser material 43 allows the light having a wavelength of 1064 nm to transmit at a light transmittance of 3%.

The pumping light (laser beams) from the semiconductor lasers 41A and 41B are collimated by the semiconductor laser optical systems 42A and 42B, and are incident into the laser material 43 through two side surfaces (the side surface perpendicular to the Z direction in FIG. 4) in two opposite direction along the Z direction.

The pumping light incident into the laser material 43 excites the Nd dopant in the laser material 43, and generates induced emission due to resonance of the resonance surfaces (surfaces in the Y direction) to induce laser oscillation and to emit laser beams in the Y direction.

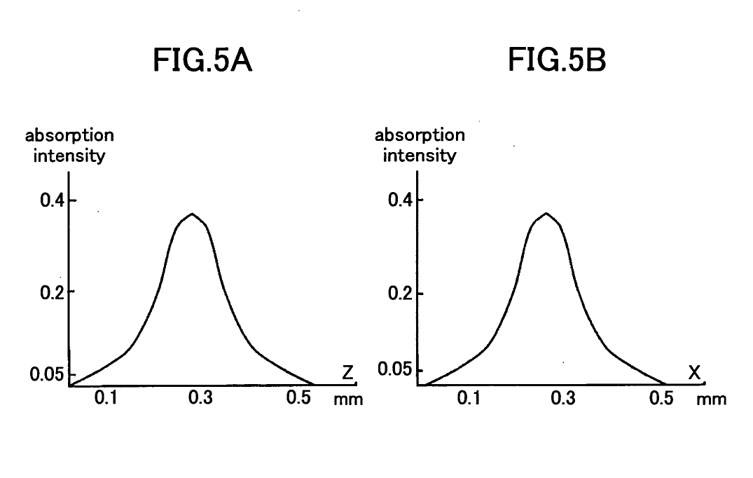

By arranging the absorption coefficients of different regions of the laser material 43 in the Z direction as summarized in Table 2, the absorption profiles of the pumping light in the laser material 43 as shown in FIG. 5A and FIG. 5B are obtained.

FIG. 5A and FIG. 5B exemplify absorption profiles of the pumping light in the laser material 43.

As shown in FIG. 5A and FIG. 5B, the light absorption reaches a maximum near the center of the laser material 43 in the X and Z direction, and decreases gradually toward two sides.

FIG. 5A exemplifies the absorption profile of the pumping light in the laser material 43 in the Z direction.

The absorption profile in the Z direction is ascribed to the distribution of the absorption coefficients of the pumping light in the laser material 43 in the Z direction as summarized in Table 2.

FIG. 5B exemplifies the absorption profile of the pumping light in the laser material 43 in the X direction.

The absorption profile in the X direction is ascribed to the fact that the incident pumping light, which has a beam diameter of 0.5 mm equaling to the width of the laser material 43 in the Z direction, has a Gaussian intensity distribution relative to the optical axis.

In a microchip laser structure, which uses the two end surfaces of the laser material as resonance surfaces, the transverse mode of the outgoing laser beam is greatly influenced by the absorption profile of the pumping light in the laser material. In the present embodiment, the absorption profiles of the pumping light as shown in FIG. 5A and FIG. 5B are similar to the absorption profiles obtained with a side-surface pumping structure, in which laser pumping occurs on a side opposite to the laser emission side. Thus, it is possible to obtain the laser transverse mode similar to that in an end surface pumping structure while using the side-surface pumping structure.

Also in the present embodiment, laser beams from a semiconductor laser array or other methods of increasing the light intensity can also be used. In this case, since the laser material 43 can be arranged to be in contact with the radiator plate 44, it is possible to obtain stable light output at a transverse mode. Even when comparing to a composite laser material, because the distribution of the absorption coefficients of the pumping light in the laser material 43 can be adjusted according to the dose of the Nd dopant, the transverse mode is in good condition.

In addition, since it is possible to realize the transverse mode in good condition with the pumping light being incident from two directions, the semiconductor laser pumped solid laser device can be made compact, and the pumping light can be made strengthened, hence, it is possible to increase the light output.

In addition, using the YAG ceramics as the laser material 43, it is possible to improve the transparency, increase light absorption by increasing dose of the Nd dopant, and facilitate fabrication of the laser material by sintering. As a result, the cost of the semiconductor laser pumped solid laser device can be reduced. Because the YAG ceramics has a high thermal conductivity, and hence it has a high efficiency of heat dissipation to the radiator plate 44, it is possible to prevent declination of light output caused by heat.

The distribution of the absorption coefficients of the pumping light in the laser material 43 is not limited to that in Table 2, but can be optimized depending on the profile of the pumping light beam or the required transverse mode. In addition, the laser material 43 is not limited to the YAG ceramics, but can be any other appropriate materials.

According to the present invention, in the semiconductor laser pumped solid laser device of the present invention, a laser beam from a semiconductor laser is incident into a laser material to excite the laser material. The laser material is a plate, whose two end surfaces act as resonance surfaces, that is, a microchip laser structure. In addition, the pumping light is incident from a side surface of the resonator other than the resonance surfaces of the laser material. The laser material is able to absorb the pumping light in the whole wavelength region, and includes plural regions each having different absorption coefficients. In addition, light absorption of the pumping light by the laser material is a maximum near a center of the plate-like laser material.

For example, the laser beam from the semiconductor laser can be incident in only one direction, or in plural directions. The laser material may be a single and uniaxial crystal, for example, Nd-doped GdVO₄. Alternatively, the laser material may be a ceramic material, specifically, the laser material may be an Nd-doped YAG ceramics.

For example, the semiconductor laser pumped solid laser device of the present invention can be used as a fundamental wave generator of a wavelength conversion solid laser device.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Japanese Priority Patent Application No. 2005-077564 filed on Mar. 17, 2005, the entire contents of which are hereby incorporated by reference.

What is claimed is:

1. A semiconductor laser pumped solid laser device, comprising:
a plate-like laser material; and
a semiconductor laser that emits a laser beam to pump the plate-like laser material to induce laser oscillation,
wherein
two end surfaces of the plate-like laser material act as two resonance surfaces of a resonator, pumping light being introduced into the resonator through other side surface of the resonator than the resonance surfaces,
the plate-like laser material includes a plurality of regions each having different absorption coefficients and possesses finite absorption coefficients for the pumping light of different wavelengths, and
absorption of the pumping light by the plate-like laser material is a maximum near a center of the plate-like laser material along an incident direction of the pumping light.

2. The semiconductor laser pumped solid laser device as claimed in claim 1, wherein the laser beam from the semiconductor laser capable of side-surface pumping is incident in only one direction.

3. The semiconductor laser pumped solid laser device as claimed in claim 1, wherein the laser beam from the semiconductor laser capable of side-surface pumping is incident in a plurality of directions.

4. The semiconductor laser pumped solid laser device as claimed in claim 1,
wherein
the laser material is a single and uniaxial crystal, and absorption of the pumping light by the laser material is adjusted by a dose of a dopant in the laser material.

5. The semiconductor laser pumped solid laser device as claimed in claim 4, wherein the laser material is obtained by doping a dopant into GdVO₄.

6. The semiconductor laser pumped solid laser device as claimed in claim 1, wherein the laser material is a ceramic material, and absorption of the pumping light by the laser material is adjusted by a dose of a dopant in the laser material.

7. The semiconductor laser pumped solid laser device as claimed in claim 6, wherein the laser material is obtained by doping a dopant into YAG ceramics.

8. The semiconductor laser pumped solid laser device as claimed in claim 5, wherein the dopant in the laser material is Nd.
